(19) United States
(12) Patent Application Publication
(10) Pub. No.: US 2026/0259829 A1
(43) Pub. Date: Sep. 3, 2026

(54) DATA EXCHANGE METHOD FOR COMPUTE EXPRESS LINK DEVICE AND DEVICE COHERENCY CIRCUIT

(71) Applicant: Montage Technology Co., Ltd., Shanghai (CN)

(72) Inventors: Yishan LIN, Shanghai (CN); Lizhi JIN, Shanghai (CN); Yaping LIU, Shanghai (CN); Zhaohui DU, Shanghai (CN); Chunhui ZHANG, Shanghai (CN); Weibin DAI, Shanghai (CN); Kun WEI, Shanghai (CN)

(21) Appl. No.: 19/208,631

(22) Filed: May 15, 2025

(30) Foreign Application Priority Data
May 15, 2024 (CN) 202410606291.2

(51) Int. Cl. G06F 12/0831; G06F 13/16; G06F 13/42

(52) U.S. Cl. CPC G06F 12/0831; G06F 13/1673; G06F 13/4282

(57) ABSTRACT

A data exchange method for a compute express link (CXL) device is provided. The method includes: receiving, via the CXL device, from the host a snoop request or a write request; storing, via the CXL device, the target address directed by the snoop request or the write request in a snoop buffer; sending, via the CXL device, to the host the target addresses and the corresponding write pointer values stored in the snoop buffer, to request the host to send data stored in a host cache and corresponding to the target addresses such that the CXL device can receive such data, and generating, via the CXL device, a completion interrupt signal to indicate all the data has been received and written into the target addresses of the device memory, when the CXL device determines that all the target addresses stored in the device memory have been sent to the host.

### TECHNICAL FIELD

The present application generally relates to computer technology, and more particularly, to a data exchange method and a data processing method for a compute express link (CXL) device.

### BACKGROUND OF THE INVENTION

The Compute Express Link (CXL) protocol is a high-speed cache-coherent interconnect protocol for processors, memory expansion, and accelerators. The CXL technology enables memory access and storage coherency between a memory space of a host (e.g., a processor) and a memory space of attached devices, thereby allowing the sharing of memory resource for better access and storage performance, reducing software stack complexity, and lowering computer system costs.

To achieve memory access coherency between the host and the attached devices, the CXL sub-protocol, CXL.cache, adopts device coherency engine (DCOH) technology or hybrid coherency engine technology as described in e.g., U.S. Patent Publication US2021/0200545A1. However, these coherency technologies have a high design complexity and low efficiency, and typically only allow memory accesses initiated by the attached device side (e.g., the accelerator side), making them incompatible with scenarios where memory accesses are initiated by the host. Additionally, data exchange between the host and the attached devices in existing CXL systems suffers from reliability issues.

Therefore, there is a need for an improved data exchange method and an improved data processing method for a CXL system.

### SUMMARY OF THE INVENTION

An objective of the present application is to provide an improved data exchange method and an improved data processing method for a CXL system to enhance the efficiency and accuracy of data exchange between CXL devices and a host.

According to an aspect of the present application, a data exchange method for a CXL device is provided. The CXL device is coupled to a host via a CXL channel, and has a device processor and a device memory, the device memory and a host memory of the host are consistently accessible by the host. The data exchange method comprises: receiving, via the CXL device, from the host a snoop request or a write request which is directed to a target address in the device memory; storing, via the CXL device, the target address directed by the snoop request or the write request in a snoop buffer, wherein each target address corresponds to a write pointer value of a write pointer in the snoop buffer; sending, via the CXL device, to the host the target addresses and the corresponding write pointer values stored in the snoop buffer, to request the host to send data stored in a host cache and corresponding to the target addresses such that the CXL device can receive such data, when the CXL device determines that the host has sent all the snoop requests or write requests or that the snoop buffer's waterline overflows; and generating, via the CXL device, a completion interrupt signal to indicate all the data has been received and written into the target addresses of the device memory, when the CXL device determines that all the target addresses stored in the device memory have been sent to the host.

According to another aspect of the present application, a data exchange processing method for a CXL protocol-based computer system is provided. The computer system comprises a host and a CXL device which are coupled to each other via a CXL channel, the host has a host processor and a host memory, the CXL device has a device processor and a device memory, the host memory and the device memory are consistently accessible by the host. The data processing method comprises: writing, via the host through the CXL channel and using the data exchange method of the aforementioned aspect, data into the device memory of the CXL device; reading, via the CXL device, the data from the device memory to the device processor, and processing, via the device processor, the data; writing, via the CXL device, a data processing result of the device processor back to the device memory; and sending, via the CXL device through the CXL channel, the data processing result to the host.

According to another aspect of the present application, a device coherency circuit is provided. The device coherency circuit comprises: a snoop buffer, configured to receive and store snoop requests or write requests, wherein each request comprises a target address, the snoop buffer comprises a write pointer and a read pointer; and the snoop buffer is further configured to update write pointer value and read pointer value based on write operation of the requested target address and read operation of stored target address; a reference write pointer value recording module, coupled to the snoop buffer to receive a write pointer value of the write pointer from the snoop buffer as a reference write pointer value, when the snoop buffer starts reading operation of the stored target addresses; an address lookup module, coupled to the snoop buffer to search in the snoop buffer for a target address corresponding to a current value of the read pointer of the snoop buffer; a request conversion module, coupled to the address query module to convert the searched target address into a RdOwnNoData request specified by a compute express link (CXL) protocol to send to the host the RdOwnNoData request and the corresponding target address, so as to allow data reception from the host; a completion recording module, configured for receiving a completion flag from the host, wherein the completion flag indicates that the write operation of the target address corresponding to the read pointer value of the read pointer requested by the RdOwnNoData request is completed; and the completion recording module has a compare pointer, and the completion recording module is further configured to update a value of the compare pointer each time a completion flag is received; and a compare module, configured for comparing the reference write pointer value with the compare pointer value, and generating an interrupt signal when the reference write pointer value is equal to the compare pointer value, to indicate that all the target addresses stored in the snoop buffer have been processed.

The above is an overview of the present application, which may be simplified, summarized, or omit details. Those skilled in the art should understand that this section is exemplary and explanatory only, and is not intended to limit the scope of the application in any way. This summary is neither intended to identify key or essential features of the claimed subject matter nor to serve as an aid in determining the scope of the claimed subject matter.

### BRIEF DESCRIPTION OF DRAWINGS

The above and other features of the present application will be more fully and clearly understood from the following description of the specification and the appended claims in conjunction with accompanying drawings. It should be understood that these drawings depict only certain embodiments of the present application, and thus should not be considered as a limitation on the content scope of the present application. The present application will be more clearly and comprehensively described using the accompanying drawings.

FIG. 1 illustrates a CXL protocol-based computer system 100 according to an embodiment of the present application.

FIG. 2 illustrates an exemplary process of steps for performing a data write operation at the slave device 104 side in the computer system 100 of FIG. 1.

FIG. 3 illustrates an example of selectively address storing performed by a snoop filter and a snoop buffer according to an embodiment of the present application.

FIG. 4 illustrates a diagram of partial modules of a device coherency (DCOH) circuit according to an embodiment of the present application.

### DETAILED DESCRIPTION OF THE INVENTION

The following detailed description refers to the accompanying drawings that form a part of the description. In the drawings, similar symbols typically identify similar components unless the context indicates otherwise. The illustrative embodiments described in the detailed description, the drawings and claims are not intended to limit. Various other embodiments may be utilized and various other changes may be made without departing from the spirit or scope of the present application. It should be understood that various aspects of the content of the present application, which are generally described herein and illustrated in the drawings, can be configured, substituted, combined, and designed in a variety of different ways, all of which are explicitly considered as part of the content of the present application.

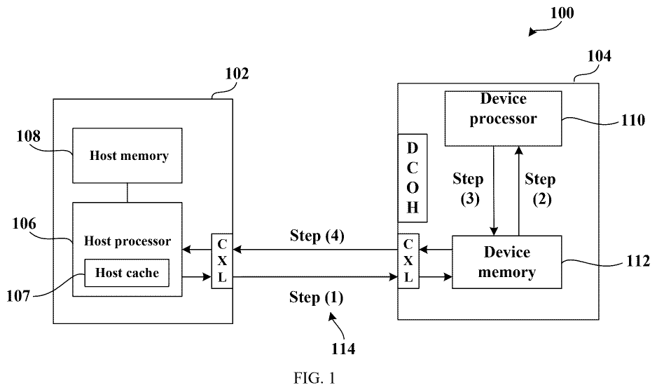

FIG. 1 illustrates a CXL protocol-based computer system 100 according to an embodiment of the present application. As shown in FIG. 1, the computer system 100 includes a host 102 and a slave device 104 which are coupled to each other via a CXL channel 114 in compliance with the CXL protocol to facilitate data exchange. In some embodiments, the slave device 104 may be a CXL Type 2 device that supports three CXL sub-protocols, namely CXL.io, CXL.cache, and CXL.mem, and thus may be referred to as a CXL device.

The host 102 includes a host processor 106 and a host memory 108. The host processor 106 can be a dedicated processor or a general-purpose processor (e.g., CPU), and the host processor 106 may include a host cache 107 which includes multiple cache lines. The slave device 104 can include a device processor 110 and a device memory 112, and the device processor 110 can be an accelerator of any type, such as an image processor, a tensor processor, or a digital signal processor and so on. Through the CXL channel 114 between the host 102 and the slave device 104, the host 102 can access the device memory 112, such as writing data into or reading data from the device memory 112. In some embodiments, the host 102 can access the device memory 112 of the slave device 104 via a CXL.mem channel compliant with the CXL.mem sub-protocol, or exchange data with the slave device 104 through a CXL.cache channel compliant with the CXL.cache sub-protocol. In this case, the slave device 104 (especially when the slave device 104 is an accelerator) internally includes a device coherency engine (DCOH), which can handle coherency-related tasks, such as snooping a device cache of the slave device 104 based on instructions on the CXL.mem channel.

The existing CXL.mem protocol specifies the implementation details for the host 102 to access the device memory 112 of the slave device 104. Specifically, under the CXL.mem protocol, transactions from the host 102 to the slave device 104 are called M2S transactions, while transactions from the slave device 104 to the host 102 are called S2M transactions. M2S transactions include two types of messages: Requests without Data (Req) and Read/Write Data Request (RwD). And S2M transactions also include two types of messages: no data responses (NDR) and data responses (DRS). The host 102 can directly access the device memory 112 through these messages. However, implementation of device coherence in the current CXL protocol is relatively complex, and in some cases, slave device 104 may be expected to perform additional functions. Therefore, it may be desired to make improvements to the computer system 100.

For example, in some applications, the host 102 may need to offload an application or partial tasks of the application to the slave device 104. The application or partial tasks of the application are executed by the device processor 110 to take advantage of data processing capabilities of the slave device 104. The computer system 100 needs to map the storage space of the device memory 112 in the slave device 104 as Host-managed Device Memory (HDM), which is accessed uniformly by the host 102 along with the host memory 108. Furthermore, offloading of the task operated by the application and access of the slave device 104 can be achieved through the following exchange process.

Specifically, still referring to FIG. 1, in step (1), the host processor 106 writes data to be processed into the device memory 112 via the CXL channel 114 (specifically, via the CXL.mem channel). As mentioned before, the host 102 uniformly accesses both the host memory 108 and the device memory 112, so the data written into the device memory 112 in step (1) can originate from the host 102. Subsequently, the slave device 104 may notify the device processor 110 via internal exchange processes that the data to be processed, such as data required for an acceleration, has been written into the device memory 112. Thus, in step (2), the device processor 110 can read the data to be processed from the device memory 112 and perform corresponding processing In step (3), the device processor 110 writes data processing results back into the device memory 112. Since steps (2) and (3) are internal operations of the slave device 104, the host 102 is not required to participate in execution. In step (4), the host processor 106 reads the data processing results from the device memory 112 via the CXL channel (specifically, via the CXL.mem channel) and optionally performs further processing on the data processing results. It should be noted that when writing the data processing results into the device memory 112 in step (3), write addresses of the data processing results may partially overlap with storage addresses of the data to be processed in step (2). This overlap may affect write operation of the data processing results and further impact read operation by the host 102 in step (4). Therefore, overlapping addresses need to be invalidated to ensure that the host 102 can ultimately read the data processing results from the device memory 112 correctly when the write addresses of the data processing results overlap with the storage addresses of the data to be processed in the device memory 112.

As can be seen from the above operations, the slave device 104 can use the internal exchange process to instruct the device processor 110 to perform specified computations or operations, realizing the processing of data on the slave device 104. The internal exchange process does not require the participation of the host 102, thus improving the operational efficiency of the computer system 100.

This application provides a data exchange method between the host 102 and the slave device 104 based on the CXL protocol and corresponding devices in some embodiments to implement data write operation in step (1) of FIG. 1, particularly when the host 102 writes a batch of data serially to the device memory 112 while ensuring that the data read by the device processor 110 is the latest written data in step (2).

FIG. 2 illustrates an exemplary process of steps for performing step (1) (i.e., the data write operation) at the slave device 104 side in the computer system 100 of FIG. 1. It should be understood that although not explicitly shown in FIG. 2, the host 102 side of the computer system 100 can perform corresponding responses and processing. In some embodiments, the exchange between the host 102 and the slave device 104 can be implemented using channels specified in the existing CXL protocol, meaning it is compatible with the existing CXL protocol. Next, FIGS. 1 and 2 will be referenced to describe in detail the data exchange process between the host 102 and the slave device 104 to implement the data write operation.

Specifically, in 1st Stage, the slave device 104 receives a snoop request and an access request from the host 102 which respectively include a target address in the device memory 112 for snooping and access.

In some embodiments, the snoop request can be an SnpData snoop request defined in the CXL protocol, which is sent by the host 102 to the slave device 104 via a H2D request channel specified in the CXL.cache sub-protocol. The access request can be an M2S transaction request specified in the CXL.mem sub-protocol, such as an M2S Req request (a request without data), which may include an operation code Mem WrFwd indicating that the request is for a write operation.

The slave device 104 may include a snoop filter, which may be set in the DCOH and may include a snoop buffer (i.e., a snoop fifo) and a snoop buffer controller (not shown). The snoop requests and the access requests can be selectively buffered in the slave device 104 through the snoop filter. Specifically, a reference address range of the storage space in the device memory 112 can be predetermined in the snoop filter, and the snoop filter can determine whether the target address included in the received request is within the reference address range of the device memory 112 and whether the target address meets the coherency property. The target address is allowed to be buffered in the snoop buffer when the target address is within the reference address range of the device memory 112 and meets the coherency property. Herein, the reference address range can be, for example, the address range of the device memory 112. The relevant parts of the CXL protocol can be referred for more details about the coherency property, which will not be described in detail here.

In an embodiment, the snoop buffer can be a FIFO memory or a register, and a depth of the snoop buffer can be configured via the register. The snoop buffer includes a read pointer (Rd_ptr) and a write pointer (Wr_ptr), which are respectively directed to the current read and write positions in the snoop buffer. After each write operation, a value of the write pointer is incremented by one to be directed to the next position to be written, while after each read operation, a value of the read pointer is incremented by one to be directed to the next position to be read. In this manner, the addresses of the currently written and read storage units can be determined and stored. Further details on the use of these pointers will be described below.

The following describes the structure and principles of the present application by taking the access request as a write request as an example.

Specifically, during the 1st Stage, the slave device 104 can store the target address in the snoop buffer when the snoop request or the write request is received, and the snoop filter determines that the target address is within the reference address range. In this case, the current write pointer value in the snoop buffer may correspond to the current target address stored, and subsequently, the write pointer value can automatically increment by 1 to correspond to the next target address to be stored. This process continues iteratively. In some embodiments, the snoop buffer only stores the target address and does not distinguish whether the target address corresponds to the snoop request or the write request. Furthermore, if multiple requests directed to the same target address (e.g., a snoop request and a write request, or two write requests) are sequentially received, the snoop buffer may store the target address multiple times. This means that multiple entries in the snoop buffer may include the same target address but correspond to different values of the write pointer. It should be noted that the target address being stored for multiple times does not affect the transmission of data from the host 102 to the slave device 104, which will be further explained below.

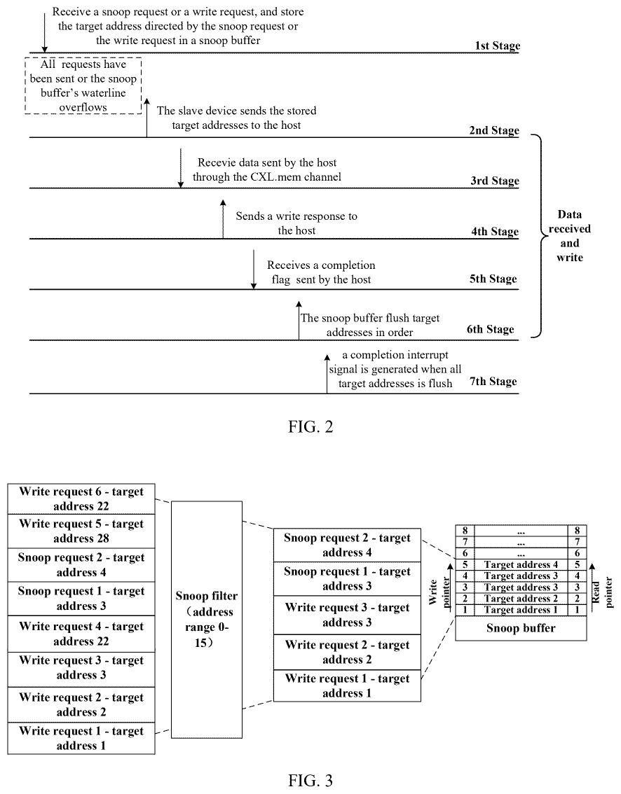

FIG. 3 illustrates an example of selectively address storing performed by a snoop filter and a snoop buffer according to an embodiment of the present application. As shown in FIG. 3, multiple write requests 1 to 6 and multiple snoop requests 1 to 2 are sequentially sent from the host to the slave device. The predetermined address range of the device memory in the snoop filter is supposed to be addresses 0 to 15. In FIG. 3, the target addresses included in the write requests 1 to 3 and the snoop requests 1 to 2 are within the predetermined address range. If the target addresses included in the write requests 1 to 3 and the snoop requests 1 to 2 also meet the coherency property, they can be stored in the snoop buffer by the snoop filter. In contrast, write requests 4 to 6, whose target addresses are not within the predetermined address range, are filtered out by the snoop filter. Additionally, even if write request 3 and snoop request 1 are both directed to target address 3, they may not be merged and then stored in the snoop buffer. In this case, the target address 3 may be stored twice to indicate that two corresponding requests from the host have been stored in the snoop buffer, as stored by write pointer 3 and 4 in the snoop buffer.

It should be understood that the snoop filter may not write a snoop request into the snoop buffer when the snoop filter determines that the target address of the snoop request is not within the reference address range. In response to the snoop request, the slave device may send a response message, such as an RspIHitI message, to the host. As specified in the CXL protocol, the RspIHitI message is used to indicate that corresponding cachelines have been cleared from the slave device.

Still referring to FIGS. 1 and 2, in some cases, particularly when the snoop buffer has a relatively large depth or when the number of snoop requests and/or write requests to be buffered is relatively small, the snoop buffer may be sufficient to store all target addresses that need to be sent to the slave device 104 without overflow. In such cases, the host 102 may send a request completion notification to the slave device 104 to indicate that all snoop requests and access requests have been sent by the host 102. Accordingly, the slave device 104 may generate a flush enable command (flush_en) and enter the 2nd Stage upon receiving the completion notification. In an embodiment, the slave device 104 further includes a mail module, and the host 102 can notify the hardware mail module via a memory mapped I/O (MMIO), prompting the mail module to generate the flush enable command.

The flush enable command can be provided to the snoop buffer, allowing the snoop buffer to determine and store the current value of the write pointer. It can be understood that the current write pointer value may be associated with the position of the last target address stored in the snoop buffer. Once the slave device 104 generates the flush enable command, the current write pointer value can serve as a reference write pointer value for sub sequent comparisons to determine whether all stored snoop requests and access requests have been completed.

In contrast, the snoop buffer's waterline may overflow in other cases, particularly when the number of requests need to be buffered is large. That is, the number of stored target addresses reaches the maximum waterline capacity of the snoop buffer while not all snoop or write requests have been received, meaning that not all the required target addresses have been stored. In this case, the slave device 104 may generate a flush enable command and enter the 2nd Stage until the snoop buffer is no longer full or until the slave device 104 generates an interrupt signal when the snoop buffer's waterline overflows. This allows new snoop requests or write requests to be received and new target addresses to be stored until all the required target addresses have been stored. It can be understood that the snoop buffer may generate multiple flush enable commands to actively process the requests stored in the snoop buffer when the number of the target addresses that need to be stored is large.

Specifically, still referring to FIGS. 1 and 2, in the 2nd Stage, the slave device 104 sends the target addresses stored in the snoop buffer during the 1st Stage along with read pointer values corresponding to all the target addresses to the host 102. It can be understood that the read pointer value can uniquely indicate the position of the corresponding target address in the snoop buffer, thus corresponding to the write pointer value.

Specifically, the snoop buffer can transfer the stored target addresses, for example, by sending them to the host 102 when the number of target addresses stored in the snoop buffer reaches the depth of the snoop buffer (i.e., maximum storable data limit), which means that the snoop buffer's waterline overflows, or when the snoop buffer has stored all target addresses of all requests and is notified to flush the stored target addresses. The slave device 104 (e.g., the snoop buffer controller) can sequentially read each stored entry in the snoop buffer. Each time a stored entry is read, the read pointer value is automatically incremented by one until all the stored entries in the snoop buffer have been read. The slave device 104 can convert the read target address of each entry into an RdOwnNoData request corresponding to the cache line in the host cache 107 associated with the read target address. The read pointer value corresponding to the target address is used as an ID of the RdOwnNoData request and is sent to the host along with the RdOwnNoData request. For example, as shown in FIG. 3, initially the read pointer is directed to the target address 1 in the snoop buffer. When the target address 1 is read, the current read pointer value (e.g., 1) is used as the ID of the RdOwnNoData request corresponding to the target address 1 and is sent to the host. And the read pointer value is then incremented by one. At this time, the read pointer is directed to the location of the target address 2. When the target address 2 is read, the current read pointer value (e.g., 2) is used as the ID of the RdOwnNoData request corresponding to the target address 2 and is sent to the host, and the read pointer value is incremented by one again. This process continues until all the stored target addresses in the snoop buffer are read. It can be understood that in FIG. 3, the target address 3, which is stored twice, may be sent as two separate RdOwnNoData requests, each with a different ID, to the host.

In some embodiments, the slave device 104 may send the RdOwnNoData request via a D2H request channel specified by the CXL.cache subprotocol to request exclusive ownership of the cache line in the host cache 107 corresponding to the target addresses.

The host 102 can match the target addresses in the received RdOwnNoData requests with tags of the cache lines in the host cache 107. If a target address matches the tag of a cache line in the host cache 107, it indicates that the cache line corresponding to the target address in the RdOwnNoData request is included in the host cache 107, which means a cache line hit occurs. In this case, the slave device 104 receives a GO-E response message from the host 102, indicating that the slave device 104 has obtained exclusive ownership of the corresponding cache line. The status of the cache line is set to “Exclusive”, meaning that the slave device 104 has exclusive ownership of that cache line. It can be understood that a cache line miss occurs when the cache line corresponding to the requested target address is not included in the host cache 107.

Next, in the 3rd Stage, the slave device 104 can continue to receive write requests sent by the host 102 after obtaining exclusive ownership of a cache line. Each write request may include a target address and data to be written. Upon receiving a write request, the slave device 104 can write the data into the device memory 112 at the target address. It can be understood that the data to be written originates from the cache line in the host cache 107. In some embodiments, the host 102 may send the write requests to the slave device through the CXL.mem channel. It can be understood that the write operations in the 3rd Stage are the same as the existing write operations specified in the CXL.mem subprotocol, and further details can be found in the CXL protocol specifications, which are not reiterated here.

Since responses to the write requests in the 3rd Stage involve actual write operations, which is different from the buffered write requests in the 1st Stage stored only for reference or ordering without actual execution. Therefore, the write requests received by the slave device 104 in the 3rd Stage do not need to be buffered in the snoop buffer and can be directly sent to the device memory 112. In other words, in the 3rd Stage, the snoop buffer can be bypassed, meaning that the write requests received by the slave device 104 in the 3rd Stage do not need to be received by the snoop buffer. A snoop buffer bypass can be implemented by configuring a register, for example, by configuring the register as “do not write to snoop buffer” mode. Conversely, when the register is configured as “write to snoop buffer” mode, the snoop buffer is enabled to receive and store corresponding requests, just as in the 1st Stage.

In the 4th Stage, the slave device 104 writes the data into the corresponding target address in the device memory 112 and sends a write response to the host 102 after the slave device 104 receives the data. The write response indicates that the data has been successfully written into the corresponding target address in the device memory 112. At this stage, data corresponding to cache lines in the host cache 107 is flushed and transferred to the device memory 112. In some cases, the slave device 104 may send the write response using an S2M message, such as a NDR specified in the CXL.mem subprotocol. It can be understood that if multiple write requests are received in the 3rd Stage, then in the 4th Stage, the slave device 104 can send multiple corresponding write responses to the host 102.

In the 5th Stage, after receiving the write response, the host 102 sends a completion flag to the slave device 104. The ID of the corresponding RdOwnNoData request is also sent along with the completion flag, where the ID corresponds to the read pointer value of the target address in the snoop buffer. In some embodiments, the host 102 may send the completion flag using an M2S message specified in the CXL.mem subprotocol, such as an operation code, MemRdFwd, in the M2S message.

It should be noted that in the 3rd Stage, the host 102 does not need to send the write requests in the same order as they are received in the 1st Stage. As shown in FIG. 3, for example, the host 102 may first send a write request corresponding to the target address 2 (corresponding to read pointer 2) and then send a write request corresponding to the target address 4 (corresponding to read pointer 5). In other words, the host 102 can send write requests in an “out-of-order” (random) manner in the 3rd Stage. However, in the 4th Stage, the slave device 104 can execute write operations in the order in which the write requests are received. For example, if the slave device 104 first receives the write request corresponding to the target address 2, the slave device 104 executes the corresponding write operation corresponding to the target address 2 first and then returns a write response to the host 102 upon completion. In the 5th Stage, the host 102 sends the completion flags and corresponding IDs in the order in which the write responses are received.

It is worth noting that in the 1st Stage, the host 102 can continuously send the snoop requests and the access requests to the slave device 104, allowing one or more target addresses to be stored in the snoop buffer. Consequently, during the 2nd to 5th Stages, the host 102 and the slave device 104 can collaboratively complete the data write operations corresponding to at least one target address stored in the snoop buffer during the 1st Stage. The snoop buffer can also further mark based on the completion flag received in the 5th Stage, which will be explained in more detail below. It can be understood that when multiple target addresses are stored in the snoop buffer, the processes in the 2nd to 5th Stages may be repeatedly executed for multiple times to process all the stored target addresses. In other words, in practical operations, it is not desired to perform the 2nd to 5th Stages separately for each target address or for each write or snoop request.

In some cases, the slave device 104 may send snoop or access requests to the host 102 corresponding to the same target address. For example, as shown in FIG. 3, the target address 3 is stored twice in the snoop buffer. However, these identical same target addresses are stored separately in the snoop buffer and correspond to different IDs, i.e., to different write pointer values. In some embodiments, during the write operations in the 2nd to 5th Stages, redundant write operations can be avoided when multiple requests directed at the same target address are responded. Specifically, when the host 102 receives the first RdOwnNoData request including the target address 3, the host 102 responds to the first request by transferring the data from the corresponding cache line in the host cache 107 to the slave device 104 and storing the data at the target address 3 in the slave device. The slave device 104 then sends a write response to the host 102. Upon receiving the write response, the host 102 sends a completion flag and the corresponding ID to the slave device 104. Unlike the processing of the first RdOwn NoData request, when the host 102 receives the second RdOwnNoData request including the target address 3, it may simply send a write response to the slave device 104 (since the operation for target address 3 has already been completed in response to the first request) without performing another write operation. In this way, each target address stored in the snoop buffer is properly processed without conflicts.

In the 6th Stage, when the slave device 104 receives the completion flag and the corresponding ID from the host, the slave device 104 determines an entry (i.e., the entry associated with a specific target address) in a completion recording module that corresponds to the received ID and marks cmp_flag, the flag bit of the entry, for example, by setting cmp_flag=1. When the entry corresponding to the marked cmp_flagis equal to the entry directed to by the compare pointer cmp_ptr, the compare pointer is updated to direct to the next entry. The compare pointer cmp_ptr serves as the read pointer in the completion recording module. When the entry corresponding to the marked cmp_flagis not equal to the entry directed to by cmp_ptr, cmp_ptrremains unchanged. When the updated cmp_ptr directs to an entry that has already been marked, cmp_ptr continues to be updated to direct to the next entry until cmp_ptr reaches an unmarked entry.

For example, it is supposed that six write requests are received in the 1st Stage, and six corresponding target addresses are stored in the snoop buffer. In the 6th Stage, when the slave device 104 first receives a completion flag and ID corresponding to entry 3, the slave device 104 marks cmp_flag corresponding to entry 3 by setting cmp_flag=1. Since the compare pointer initially directs to entry 1, and entry 3 is not equal to entry 1, the compare pointer cmp_ptr remains unchanged and directs to entry 1. When the slave device 104 receives a second completion flag and ID correspond to entry 1, the slave device 104 marks cmp_flag corresponding to entry 1. Since entry 1 is equal to the entry directed to by the compare pointer cmp_ptr, the compare pointer is updated to direct to entry 2. When the slave device 104 receives a third completion flag and ID correspond to entry 4, the slave device 104 marks cmp_flag corresponding to entry 4 and does not update compare pointer, thus the cmp_ptr remains at entry 2. When the slave device 104 receives the fourth completion flag and ID correspond to entry 2, the slave device 104 updates the compare pointer cmp_ptr to direct to entry 3. At this point, since entry 3 and entry 4 have already been marked, the compare pointer is further updated to direct to entry 5, and so on until all six entries are marked, and the compare pointer update is completed.

As indicated in the 6th Stage, after marking the cmp_flag for each entry, the slave device 104 also compares the current read pointer cmp_ptr with the write pointer stored using the flush_en pulse in the 1st Stage (i.e., the reference write pointer value). When the compare pointer value increases to be equal to the reference write pointer value, a completion interrupt signal is generated to initiate subsequent operations. The completion interrupt signal indicates that all target addresses stored in the snoop buffer have been processed.

Through the 6th Stage, the compare pointer is updated in the order in which requests are received by the snoop buffer, ensuring instruction ordering and write serialization. Thus, even if the slave device 104 receives write requests from the host 102 out of order, the data write operations are still performed in the order in which the write requests are originally sent. Similarly, for other access requests sent by the host 102, the slave device 104 can maintain ordered processing.

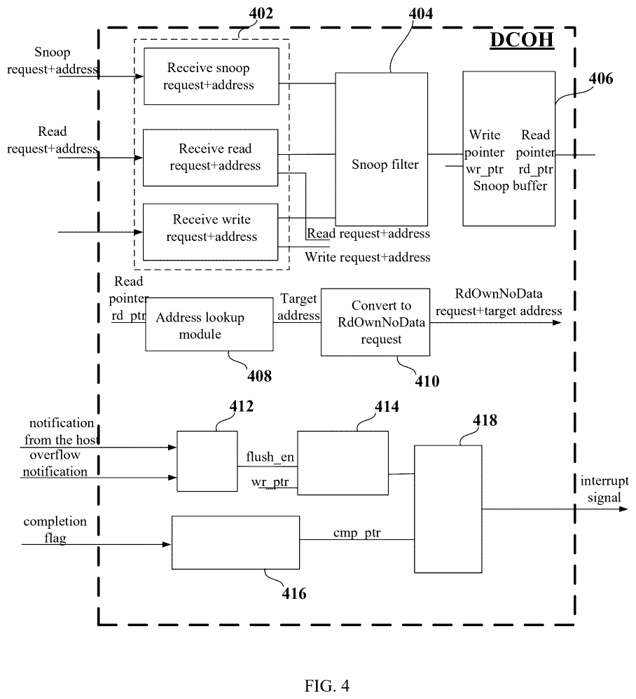

FIG. 4 illustrates a diagram of partial modules of a device coherency (DCOH) circuit according to an embodiment of the present application. In some embodiments, the device coherency circuit may be implemented within the device coherency engine (DCOH) shown in FIG. 1 and may be used to execute the data exchange processing described in FIG. 2.

As shown in FIG. 4, the device coherency circuit includes a request receiving channel 402 having multiple subchannels for separately receiving snoop requests, read requests and write requests from the host. Each request includes a corresponding target address, which is the address of a storage unit being accessed in the device memory. It can be understood that in some embodiments, each subchannel may be implemented by hardware, and in other embodiments, each subchannel may be implemented by software.

The various access requests received by the request receiving channel 402 may be provided to a snoop filter 404, which processes the various access requests. Specifically, the snoop filter 404 determines whether the target address included in the request is within the reference address range and whether it meets the coherency property. Only requests that are within the reference address range and meet the coherency property are provided to and stored by a snoop buffer 406. It can be understood that, in some cases, the device coherency circuit may also forward read and write requests received from the host directly to a post-stage bus (e.g., the access bus of the device memory) and the device memory (not shown) without passing through a snoop buffer 406. This allows the slave device to access the device memory in response to these requests. Therefore, the request receiving channel 402 may also include an output interface coupled to the device memory, enabling direct provision of at least read and write requests to the device memory while bypassing the snoop filter 404 and the snoop buffer 406. This allows the device memory to execute access operations of read or write requests according to the normal processing flow and method.

The structure and working principle of the device coherency circuit shown in FIG. 4 are described below using a write request as an example. It can be understood that more details about the device coherency circuit can be found in the related description of the data exchange process shown in FIG. 2.

As described in conjunction with FIG. 2, the snoop buffer 406 may include a write pointer (wr_ptr) and a read pointer (rd_ptr), and may update a write pointer value and a read pointer value based on a write operation of the requested target address and a read operation of stored target address, respectively. In some embodiments, the snoop buffer 406 may be a first-in-first-out (FIFO) cache. In the embodiment shown in FIG. 4, the snoop buffer 406 is coupled to the snoop filter 404 to receive snoop requests and write requests (specifically, the requested target addresses) and update the write pointer value based on the requested target addresses. However, the snoop buffer 406 is also coupled to other modules through additional interfaces. For example, upon receiving a flush enable command, the snoop buffer 406 may provide the current write pointer value to a reference write pointer value recording module 414, which records this current value as the reference write pointer value. As mentioned before, the reference write pointer value serves as a compare value to determine whether the stored target addresses in the snoop buffer 406 have been completely flushed. The reference write pointer value is provided to a compare module 418 for reference when determining whether the snoop buffer 406 has been completely flushed.

In the a shown in FIG. 4, the flush enable (flush_en) command may be generated by a mail module 412 and provided to the reference write pointer value recording module 414. In some embodiments, the mail module 412 may be coupled to the host and receive a notification from the host indicating that all requests have been sent. Accordingly, the mail module 412 generates a corresponding flush enable command. Additionally, the mail module 412 may be coupled to the snoop buffer 406 and receive an overflow notification from the snoop buffer 406 when the snoop buffer 406 overflows. Consequently, the mail module 412 may generate a corresponding flush enable command based on the overflow notification. As described in the embodiment shown in FIG. 2, when the number of requests that need to be buffered is large (e.g., exceeding the storage capacity of the snoop buffer 406), the snoop buffer 406 may overflow and generate the overflow notification, instructing the mail module 412 to start the flushing operation of the snoop buffer 406.

The compare module 418 also receives another input signal, which is the updated value of the read pointer from the snoop buffer 406. Specifically, the device coherency circuit may include an address lookup module 408 to search in the snoop buffer 406 for a target address corresponding to a current value of the read pointer (i.e., the ID) of the snoop buffer 406. After the corresponding target address is searched, the device coherency circuit converts the searching target address into an RdOwnNoData request through a request conversion module 410. Subsequently, the request is sent to the host via a D2H request channel, along with the corresponding target address. If the host includes a cache line corresponding to the target address included in the RdOwnNoData request, which means a cache line hit occurs, the slave device receives a GO-E response message from the host in response to the RdOwnNoData request, indicating that the slave device has obtained exclusive access to the corresponding cache line whose status is set to “Exclusive”. As a result, the slave device can receive write data from the host, and the write data is directed to the corresponding target address in the device memory. Once the slave device receives the write data, the slave device sends a write response to the host, indicating that the data has been written into the corresponding target address in the device memory. The host then continues to send a completion flag to the slave device, along with the ID corresponding to the RdOwnNoData request. The completion flag is received by a completion record module 416 of the device coherency circuit, which stores and updates a value of a cmp_ptr based on the received completion flag and the corresponding ID. It can be understood that, after each completion flag is processed, both the compare pointer and the read pointer of the snoop buffer 406 are incremented by 1 to enable continue reading other target addresses.

Thus, the compare module 418 in the snoop buffer compares the reference write pointer value with the compare pointer value. It indicates that all buffered target addresses in the snoop buffer 406 have been flushed when the reference write pointer value is equal to the compare pointer value, which means that flush operation is completed. Accordingly, at this point, the compare module 418 generates an interrupt signal. The interrupt signal may be provided to the device processor of the slave device, enabling the device processor to process the data stored in the device memory, specifically performing the processing operation described in step (2) of FIG. 2.

It can be understood that the device coherency circuit may include additional registers to receive configuration data to configure whether the data exchange method described in this application should be implemented, i.e., whether snoop requests and access requests should be buffered in the snoop buffer. If the registers are configured to disable the data method described in this application, the device coherency circuit allows the slave device to exchange with the host in the same way as existing CXL.mem products.

As demonstrated, the data exchange method, data processing method, and device coherency circuit of the CXL system described in this application have minimal hardware overhead and are easy to design and implement. Furthermore, these methods and circuits are highly compatible with existing CXL systems and devices, thereby reducing application costs. Additionally, by recording and marking requests in the snoop buffer, the method ensures “ordering” and write serialization of request processing. This means that even if requests are received out of order from the host, the data operations may still be executed in the order the requests are sent, significantly enhancing the stability and accuracy of data exchanges.

In some embodiments, this application also provides certain computer program products that include a non-transitory computer-readable storage medium. This non-transitory computer-readable storage medium includes computer-executable code for executing the steps described in the above embodiments of this application.

The embodiments of the present invention may be implemented through hardware, software, or a combination of both. The hardware portion may be implemented using dedicated logic, while the software portion may be stored in memory and executed by an appropriate instruction execution system, such as a microprocessor or a dedicated hardware. Those skilled in the art will understand that the described devices and methods can be implemented using computer-executable instructions and/or processor control code contained in a storage medium, such as a disk, CD, DVD-ROM, firmware, or a programmable storage device such as a ROM, or through data carriers such as optical or electronic signals. The device and its modules in this invention may be implemented using hardware circuits such as Very Large Scale Integration or gate arrays, semiconductor components such as logic chips or transistors, programmable hardware devices such as Field Programmable Gate Arrays or Programmable Logic Devices, software executed by various types of processors, or a combination of hardware and software such as firmware.

Although only the write request is taken as an example to introduce the structure and principle of the circuit in this application, the application is not limited to this and can be applied to all types of requests, such as snoop requests and access requests.

It should be noted that although several steps of the data exchange method and data processing method for CXL devices and computer systems based on the CXL protocol, as well as several modules of the device coherency circuit, are mentioned in the above detailed description, such division is merely exemplary and not mandatory. In fact, according to the embodiments of the present application, the features and functions of two or more steps described above can be embodied in one step. Conversely, the features and functions of one step described above can be further divided into multiple steps for implementation.

Those of ordinary skill in the art can understand and implement other changes to the disclosed embodiments by studying the specification, the disclosed content, the accompanying drawings, and the appended claims. In the claims, the word “comprising” does not exclude other elements and steps, and the terms “a” and “an” do not exclude a plurality. In the practical application of the present application, one component may perform the functions of multiple technical features recited in the claims. Any reference signs in the claims should not be considered as limitation to the scope.

1. A data exchange method for a compute express link (CXL) device, wherein the CXL device is coupled to a host via a CXL channel, and has a device processor and a device memory, the device memory and a host memory of the host are consistently accessible by the host; and wherein the data exchange method comprises:
receiving, via the CXL device, from the host a snoop request or a write request which is directed to a target address in the device memory;
storing, via the CXL device, the target address directed by the snoop request or the write request in a snoop buffer, wherein each target address corresponds to a write pointer value of a write pointer in the snoop buffer;
sending, via the CXL device, to the host the target addresses and the corresponding write pointer values stored in the snoop buffer, to request the host to send data stored in a host cache and corresponding to the target addresses such that the CXL device can receive such data, when the CXL device determines that the host has sent all the snoop requests or write requests or that the snoop buffer's waterline overflows; and
generating, via the CXL device, a completion interrupt signal to indicate all the data has been received and written into the target addresses of the device memory, when the CXL device determines that all the target addresses stored in the device memory have been sent to the host.

2. The data exchange method of claim 1, wherein before the storing step, the method further comprises:
comparing, via the CXL device using a snoop filter of the CXL device, the target address with a predetermined reference address range; and
when the CXL device determines that the target address is within the reference address range, performing the storing step.

3. The data exchange method of claim 1, wherein the CXL device determines that all the target addresses stored in the device memory have been sent to the host using the following steps:
determining, via the CXL device, a write pointer value corresponding to a target address lastly stored in the snoop buffer as a reference write pointer value;
reading out, via the snoop buffer, target addresses stored within the snoop buffer in an order using a read pointer, to output the target addresses from the CXL device to the host, wherein a read pointer value of the read pointer is incremented by one each time one of the target addresses is read out from the snoop buffer and the CXL device determines that data has been written into the target address of the device memory; and
determining, via the CXL device, all the target addresses stored in the snoop buffer have been sent to the host when the read pointer value of the read pointer equals the reference write pointer value.

4. The data exchange method of claim 3, wherein the CXL device determines that data has been written into a target address of the device memory using the following steps:
receiving, via the CXL device, from the host data and writing the data into the corresponding address in the device memory;
sending, via the CXL device, a write response to the host to indicate that the data has been written into the target address; and
receiving, via the CXL device, a completion flag from the host to indicate that the write operation of the target address is completed.

5. The data exchange method of claim 1, wherein the sending step comprises the following step:
sending, via the CXL device using a RdOwnNoData request specified by the CXL protocol, the target address and the corresponding write pointer value.

6. A data exchange method for a compute express link (CXL) protocol-based computer system, wherein the computer system comprises a host and a CXL device which are coupled to each other via a CXL channel, the host has a host processor and a host memory, the CXL device has a device processor and a device memory, the host memory and the device memory are consistently accessible by the host; and wherein the data exchange method comprises:
sending from the host to the CXL device a snoop request or a write request which is directed to a target address in the device memory;
storing, via the CXL device, the target address directed by the snoop request or the write request in a snoop buffer of the CXL device, wherein each target address corresponds to a write pointer value of a write pointer in the snoop buffer;
sending from the CXL device to the host the target addresses and the corresponding write pointer values stored in the snoop buffer, to request the host to send data stored in a host cache of the host and corresponding to the target addresses, when the CXL device determines that the host has sent all the snoop requests or write requests or that the snoop buffer's waterline overflows;
sending from the host to the CXL device the data stored in the host cache and corresponding to the target addresses and receiving via the CXL device such data; and
generating, via the CXL device, a completion interrupt signal to indicate all the data has been received and written into the target addresses of the device memory, when the CXL device determines that all the target addresses stored in the device memory have been sent to the host.

7. The data exchange method of claim 6, wherein before the storing step, the method further comprises:
comparing, via the CXL device using a snoop filter of the CXL device, the target address with a predetermined reference address range; and
when the CXL device determines that the target address is within the reference address range, performing the storing step.

8. The data exchange method of claim 6, wherein the CXL device determines that all the target addresses stored in the device memory have been sent to the host using the following steps:
determining, via the CXL device, a write pointer value corresponding to a target address lastly stored in the snoop buffer as a reference write pointer value;
reading out, via the snoop buffer, target addresses stored within the snoop buffer in an order using a read pointer, to output the target addresses from the CXL device to the host, wherein a read pointer value of the read pointer is incremented by one each time one of the target addresses is read out from the snoop buffer and the CXL device determines that data has been written into the target address of the device memory; and
determining, via the CXL device, all the target addresses stored in the snoop buffer have been sent to the host when the read pointer value of the read pointer equals the reference write pointer value.

9. The data exchange method of claim 8, wherein the CXL device determines that data has been written into a target address of the device memory using the following steps:
receiving, via the CXL device, from the host data and writing the data into the corresponding address in the device memory;
sending, via the CXL device, a write response to the host to indicate that the data has been written into the target address; and
receiving, via the CXL device, a completion flag from the host to indicate the write operation of the target address is completed.

10. The data exchange method of claim 9, wherein the step of sending from the CXL device to the host the target addresses and the corresponding write pointer values stored in the snoop buffer comprises the following step:
sending, via the CXL device using a RdOwnNoData request specified by the CXL protocol, the target address and the corresponding write pointer value.

11. A data processing method for a compute express link (CXL) protocol-based computer system, wherein the computer system comprises a host and a CXL device which are coupled to each other via a CXL channel, the host has a host processor and a host memory, the CXL device has a device processor and a device memory, the host memory and the device memory are consistently accessible by the host; and wherein the data processing method comprises:
writing, via the host through the CXL channel and using the data exchange method of claim 6, data into the device memory of the CXL device;
reading, via the CXL device, the data from the device memory to the device processor, and processing, via the device processor, the data;
writing, via the CXL device, a data processing result of the device processor back to the device memory; and
sending, via the CXL device through the CXL channel, the data processing result to the host.

12. A device coherency circuit, comprising:
a snoop buffer, configured to receive and store snoop requests or write requests, wherein each request comprises a target address, the snoop buffer comprises a write pointer and a read pointer; and the snoop buffer is further configured to update write pointer value and read pointer value based on write operation of the requested target address and read operation of stored target address;
a reference write pointer value recording module, coupled to the snoop buffer to receive a write pointer value of the write pointer from the snoop buffer as a reference write pointer value, when the snoop buffer starts reading operation of the stored target addresses;
an address lookup module, coupled to the snoop buffer to search in the snoop buffer for a target address corresponding to a current value of the read pointer of the snoop buffer;
a request conversion module, coupled to the address query module to convert the searched target address into a RdOwnNoData request specified by a compute express link (CXL) protocol to send to the host the RdOwnNoData request and the corresponding target address, so as to allow data reception from the host;
a completion recording module, configured for receiving a completion flag from the host, wherein the completion flag indicates that the write operation of the target address corresponding to the read pointer value of the read pointer requested by the RdOwnNoData request is completed; and the completion recording module has a compare pointer, and the completion recording module is further configured to update a value of the compare pointer each time a completion flag is received; and
a compare module, configured for comparing the reference write pointer value with the compare pointer value, and generating an interrupt signal when the reference write pointer value is equal to the compare pointer value, to indicate that all the target addresses stored in the snoop buffer have been processed.

13. The device coherency circuit of claim 12, further comprising:
a mail module, configured for receiving a notice from the host and generating a read enable command to instruct the snoop buffer to start read operations.

14. The device coherency circuit of claim 13, wherein the mail module is further configured to generate the read enable command according to an overflow notification provided by the snoop buffer's waterline.

15. The device coherency circuit of claim 12, further comprising:
a request receiving channel having multiple subchannels for receiving from the host snoop requests, read requests and write requests, respectively; wherein the request receiving channel is configured to selectively provide the received requests to the snoop buffer or a device memory coupled to the device coherency circuit.

16. The device coherency circuit of claim 15, further comprising:
a snoop filter coupled between the request receiving channel and the snoop buffer, and configured to filter the snoop requests, read requests and write requests to provide target addresses to the snoop buffer when the target addresses are within a predetermined reference address range.
